(19) United States
(12) Patent Application Publication
(10) Pub. No.: US 2026/0292271 A1
(43) Pub. Date: Sep. 24, 2026

(54) METHOD, APPARATUS FOR PROCESSING MEDIA STREAM, AND DEVICE, MEDIUM AND PRODUCT

(71) Applicant: Beijing Zitiao Network Technology Co., Ltd., Beijing (CN)

(72) Inventors: Zhuoyao DENG, Beijing (CN); Nanshan LIAO, Beijing (CN); Zhi LI, Beijing (CN); Yuhua LING, Beijing (CN); Suliu FENG, Beijing (CN); Li ZHANG, Beijing (CN)

(21) Appl. No.: 19/577,223

(22) Filed: Mar. 24, 2026

(30) Foreign Application Priority Data
Mar. 24, 2025 (CN) 202510353798.6

(51) Int. Cl. H04N 21/2187

(52) U.S. Cl. CPC H04N 21/2187

(57) ABSTRACT

Embodiments of the present disclosure relate to a method, an apparatus, a device, a medium, and a product for processing a media stream. The method includes receiving, via a first channel, a media stream for live streaming. The method further includes determining whether a predetermined number of information items are lost from the media stream within a predetermined period of time. The method further includes in response to the predetermined number of information items being lost from the media stream within the predetermined period of time, obtaining a target backup information item corresponding to the target media frame, the target backup information item being received via a second channel and including the supplementary enhancement information. The method further includes controlling a display of the media stream based on the target backup information item and the media stream.

### CROSS-REFERENCE TO RELATED APPLICATION(S)

This application claims priority to Chinese Application No. 202510353798.6 filed March 24, 2025, the disclosure of which is incorporated herein by reference in its entirety.

### TECHNICAL FIELD

Embodiments of the present disclosure generally relate to the field of live streaming, and in particular, to a method, an apparatus, a device, a medium, and a product for processing a media stream.

### BACKGROUND

At present, in a live streaming scenario, more and more live streaming content is discovered and used to show to a large number of audiences watching the live streaming, and the content includes popularizing knowledge, entertaining the public, competitive games, and the like. In the process of live streaming by a streamer, the streamer usually interacts with other streamers or audiences, and other streamers or audiences in a live streaming room may participate in the interaction together by inputting words or giving gifts. When the popularity of the live streaming room becomes higher and higher, the number of people participating in the interaction in the live streaming room will become more and more, and at this time, related interactive operations in the live streaming room will become more and more frequent, and the load pressure of the live streaming room will gradually increase.

With the rise of the live streaming industry, more and more people begin to pay attention to this field and join the live streaming industry, and the number of streamers in the current live streaming industry has shown a blowout growth. With the sharp increase in the number of people in a streamer's live streaming room, the number of audiences in the live streaming room is also increasing, and the number of audiences in live streaming rooms of different streamers is also different. Therefore, the live streaming pressure for the live streaming rooms of different streamers is not the same. With the continuous increase in the number of audiences and the performance of devices gradually reaching a threshold, more stringent challenges are brought about in improving the stability and reliability of live streaming.

### SUMMARY

Embodiments of the present disclosure provide a method, an apparatus, a device, a medium, and a product for processing a media stream.

According to a first aspect of the present disclosure, there is provided a method for processing a media stream. The method includes receiving, via a first channel, a media stream for live streaming. The method further includes determining whether a predetermined number of information items are lost from the media stream within a predetermined period of time, a target information item of the predetermined number of information items including supplementary enhancement information for a target media frame in the media stream. The method further includes in response to the predetermined number of information items being lost from the media stream within the predetermined period of time, obtaining a target backup information item corresponding to the target media frame, the target backup information item being received via a second channel and including the supplementary enhancement information. The method further includes controlling a display of the media stream based on the target backup information item and the media stream.

In a second aspect of the present disclosure, there is provided a method for processing a media stream. The method includes determining a target information item and a target timestamp of a target media frame in a media stream for live streaming, the target information item including supplementary enhancement information for the target media frame. The method further includes determining a target backup information item for the target information item, the target backup information item including the supplementary enhancement information. The method further includes generating an additional message based on the target backup information item and the target timestamp. The method further includes sending the media stream via a first channel and sending the additional message via a second channel to control the display of the media stream.

In a third aspect of the present disclosure, there is provided an apparatus for processing a media stream. The apparatus includes a media stream receiving module configured to receive, via a first channel, a media stream for live streaming; a predetermined number of lost information items determining module configured to determine whether a predetermined number of information items are lost from the media stream within a predetermined period of time, a target information item of the predetermined number of information items including supplementary enhancement information for a target media frame in the media stream; a target backup information item obtaining module configured to, in response to the predetermined number of information items being lost from the media stream within the predetermined period of time, obtain a target backup information item corresponding to the target media frame, the target backup information item being received via a second channel and including the supplementary enhancement information; and a media stream display controlling module configured to control the display of the media stream based on the target backup information item and the media stream.

In a fourth aspect of the present disclosure, there is provided an apparatus for processing a media stream. The apparatus includes a target information item and a target timestamp determining module configured to determine a target information item and a target timestamp of a target media frame in a media stream for live streaming, the target information item including supplementary enhancement information for the target media frame; a target backup information item determining module configured to determine a target backup information item for the target information item, the target backup information item including the supplementary enhancement information; an additional message generating module configured to generate an additional message based on the target backup information item and the target timestamp; and a media stream and additional message sending module configured to send the media stream via a first channel and send the additional message via a second channel to control the display of the media stream.

In a fifth aspect of the present disclosure, there is provided an electronic device. The electronic device includes at least one processor; and a memory for storing at least one program, the at least one program, when executed by the at least one processor, causing the at least one processor to implement the method according to the first aspect or the second aspect of the present disclosure.

In a sixth aspect of the present disclosure, there is provided a computer-readable storage medium. The computer-readable storage medium stores a computer program which, when executed by a processor, implements the method according to the first aspect or the second aspect of the present disclosure.

In a seventh aspect of the present disclosure, there is provided a computer program product. The computer program product includes a computer program which, when executed by a processor, implements the method according to the first aspect or the second aspect of the present disclosure.

It should be appreciated that content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other objects, features and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 is a schematic diagram of an example environment in which a device and/or a method of some embodiments of the present disclosure may be implemented;

FIG. 2 is a schematic diagram of an example method for processing a media stream according to some embodiments of the present disclosure;

FIG. 3 is a schematic diagram of another example method for processing a media stream according to some embodiments of the present disclosure;

FIG. 4 is a schematic diagram of an example of a flowchart for processing a media stream according to some embodiments of the present disclosure;

FIG. 5 is a schematic diagram of an example for detecting an information item according to some embodiments of the present disclosure;

FIG. 6 is a schematic diagram of an example for determining a target backup information item according to some embodiments of the present disclosure;

FIG. 7 is a schematic diagram of another example for determining a target backup information item according to some embodiments of the present disclosure;

FIG. 8 is a schematic block diagram of an apparatus for processing a media stream according to some embodiments of the present disclosure;

FIG. 9 is a schematic block diagram of an apparatus for processing a media stream according to some embodiments of the present disclosure; and

FIG. 10 is a schematic block diagram of an example device suitable for implementing multiple embodiments of the present disclosure.

In each figure, the same or corresponding reference numerals represent the same or corresponding parts.

### DETAILED DESCRIPTION OF EMBODIMENTS

It should be appreciated that data involved in the technical solution (including but not limited to the data itself, acquisition or use of the data) should comply with requirements of corresponding laws, regulations, and related provisions.

It should be appreciated that before the use of the technical solution disclosed in the embodiments of the present disclosure, the user shall be informed of the type, range of use, use scenarios, etc., of personal information involved in the present disclosure in an appropriate manner and the authorization of the user shall be obtained in accordance with related laws and regulations.

For example, when receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to select "agree" or "disagree" to provide the personal information to the electronic device.

It should be appreciated that the above process of notifying and obtaining user authorization is only illustrative and does not limit the implementations of the present disclosure, and other manners that satisfy the related laws and regulations may also be applied in the implementations of the present disclosure.

The embodiments of the present disclosure will be described in more detail below with reference to the drawings. Although some embodiments of the present disclosure are shown in the drawings, it should be appreciated that the present disclosure may be implemented in various forms and should not be construed as limited to the embodiments set forth herein. Instead, these embodiments are provided for a more thorough and complete understanding of the present disclosure. It should be appreciated that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "based at least in part on". The term "an embodiment" or "the embodiment" should be understood as "at least one embodiment". The terms "first", "second", etc. may refer to different or same objects. Other definitions, either explicit or implicit, may also be included below.

In the process of processing a media stream, for example, a scenario of live streaming by a streamer is taken as an example. When a user is watching the live streaming of the streamer, the user receives not only a video stream from a streamer side, but also supplemental enhancement information (SEI) from the video stream. The SEI is defined in a video bitstream, and is used to provide a way of adding information to the video bitstream. The information for the live streaming, such as a nickname of the streamer, an identification of the streamer, a room number, and a layout of the live streaming room, may be added to the SEI. However, the SEI may be lost during the transmission of the video bitstream due to various factors, and thus cannot be transmitted to an audience side or a playing side.

In the above traditional solution, in the process of live streaming, especially in the media stream transmission link in the process of live streaming, some functions or live streaming effects during live streaming rely on the SEI in the video bitstream, and thus the SEI is particularly important. For live streaming, many service scenarios rely on the SEI to achieve alignment between data and stream pictures, such as a layout of player killing (PK) and a display of a "health bar", a layout style and letter information in a multi-user scenario, a lyrics musical instrument digital interface (MIDI) progress in a singing scenario, an interactive component, a progress bar and a program list in a program scenario, and a dual-screen layout in game live streaming, all of which need to be obtained through the SEI in the video bitstream.

However, in an actual transmission link process of the video bitstream, the SEI may be lost in the transmission link due to transcoding implementation of a content delivery network (CDN), a frame dropping policy, video format compatibility issues, and the like. In this case, the stability of the data transmission link cannot be guaranteed, which will lead to availability problems due to the limitation of the SEI, and the user experience in a live streaming scenario is seriously degraded.

At least to solve the above and other potential problems, embodiments of the present disclosure provide a method for processing a media stream. In the method, a media stream for live streaming may be received via a first channel. Next, after the media stream is received, it is determined whether a predetermined number of information items are lost from the media stream within a predetermined period of time. A target information item of the predetermined number of information items includes supplementary enhancement information for a target media frame in the media stream. Then, after it is determined that the predetermined number of information items are lost from the media stream within the predetermined period of time, a target backup information item corresponding to the target media frame is obtained. The target backup information item is received via a second channel and includes the supplementary enhancement information. Finally, the display of the media stream is controlled based on the target backup information item and the media stream. Through the method, multiple transmission channels may be used to transmit the information items for live streaming, and backup information items may be provided to increase the stability and reliability of live streaming. In the case that the information items are lost due to poor network conditions, the transmitted backup information items may be used to improve the stability of live streaming, thereby improving the audience experience.

It should be appreciated that the present disclosure is only illustrated in combination with related embodiments, and the related embodiments are not used to limit the protection scope of the present disclosure. Any technical solution in other disclosures that falls within the protection scope of the present disclosure should be protected.

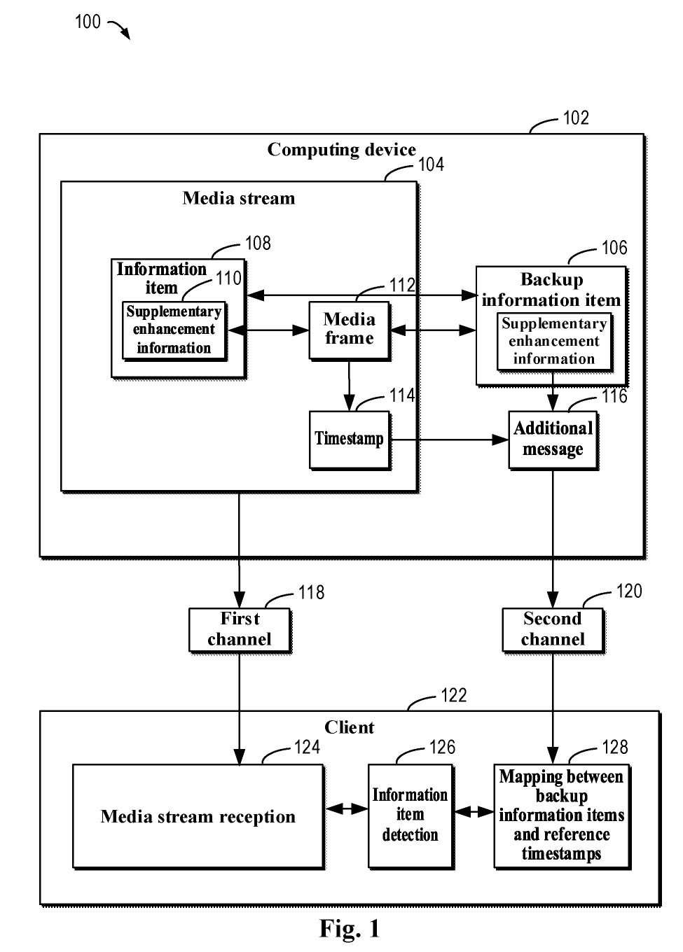

The embodiments of the present disclosure will be further described in detail below in conjunction with the drawings. FIG. 1 shows an example environment in which a device and/or a method of the embodiments of the present disclosure may be implemented. In an environment 100, taking a live streaming scenario as an example, a computing device 102 may be configured to provide a media stream for live streaming to a client 122. In an example, the media stream is a media stream for game live streaming. In another example, the media stream may be a media stream in a multi-user connection scenario, such as a media stream in a singing scenario or a media stream in a connected competition scenario. The client 122 may be a device on the audience side for watching live streaming. The computing device 102 and the client 122 may communicate via a first channel 118 and a second channel 120. A transmission mode of the first channel is different from a transmission mode of the second channel. For example, the first channel includes a content delivery network, and the second channel includes a service server for live streaming, some open source data transmission platforms, and the like.

Examples of the computing device 102 and the client 122 include, but are not limited to, personal computers, server computers, handheld or laptop devices, mobile devices (such as mobile phones, personal digital assistants (PDAs), media players, etc.), multi-processor systems, consumer electronic products, minicomputers, mainframe computers, distributed computing environments including any of the above systems or devices, etc.

As shown in FIG. 1, taking the live streaming scenario as an example, the computing device 102 may generate a media stream 104 provided to the client 122. The client 122 used by the audience may first receive the media stream 104 for live streaming from the computing device 102 via the first channel 118. In an example, the computing device 102 may be a streamer side. In another example, the computing device 102 may also be a real time communication (RTC) server for live streaming services. The streamer side or the RTC server side may transmit the media stream 104 for live streaming to the client 122 through the first channel 118.

In an example, the media stream 104 may include a video stream for live streaming. In another example, the media stream 104 may include an audio stream for live streaming. In yet another example, the media stream 104 may further include a video stream and an audio stream for live streaming. Additionally, the media stream 104 may further include information such as an identity of the streamer, a timestamp corresponding to the live streaming, and a room identification of the live streaming room.

In order to ensure the display of the media stream, the computing device 102 may generate corresponding supplementary enhancement information for the media frame in the media stream 104, and add the supplementary enhancement information to the media stream as an information item. Therefore, the media stream 104 may include multiple media frames and multiple information items. For example, a corresponding information item may be set for each media frame in the media stream. The client 122 may perform media stream reception 124, and after receiving the media stream, the client may further perform information item detection 126. During the information item detection 126, the client 122 may determine whether a predetermined number of information items are lost from the media stream 104 within a predetermined period of time. In addition to the media frame and the information item for the media frame, the media stream 104 may further include a timestamp for each media frame, such as a presentation time stamp (PTS) for each media frame. It should be appreciated that all media frames in the media stream 104 include timestamps corresponding thereto.

If the predetermined number of information items are not lost from the media stream 104 within the predetermined period of time, the information item obtained from the media stream 104 is used to present the media stream. However, if it is determined that the predetermined number of information items are lost from the media stream 104 within the predetermined period of time, the client 122 may further obtain a backup information item corresponding to the media frame in the period of time, for example, if the predetermined number of information items include a target information item 108, a target backup information item 106 corresponding to a target media frame 112 is obtained. The target backup information item 106 is transmitted to the client 122 via the second channel 120 and includes supplementary enhancement information for the target media frame 112. The supplementary enhancement information in the target backup information item 106 is the same as supplementary enhancement information 110 in the target information item 108, and thus the target backup information item 106 is a backup of the target information item 108.

When the target backup information item is transmitted from the computing device 102 to the client 122, the computing device 102 may use a target timestamp 114 and the target backup information item 106 to generate an additional message 116. The additional message 116 may be sent to the client 122 via the second channel 120.

Finally, after the additional message 116 is sent to the client 122 via the second channel 120, a mapping 128 between backup information items and reference timestamps may be generated using the backup information items and the reference timestamps of other received media frames. The mapping 128 between the backup information items and the reference timestamps may be a list for storing the backup information items and the reference timestamps. For example, the above-mentioned target backup information item 106 is obtained by searching the mapping using the target timestamp corresponding to the target media frame. Next, the received media stream 104 and the target backup information item 106 may be used to control the display of the media stream 104 on the client 122.

Through the method, multiple transmission channels may be used to transmit the information items for live streaming, and backup information items may be provided to increase the stability and reliability of live streaming. In the case that the information items are lost, the transmitted backup information items may also be used to improve the stability of live streaming, thereby improving the audience experience.

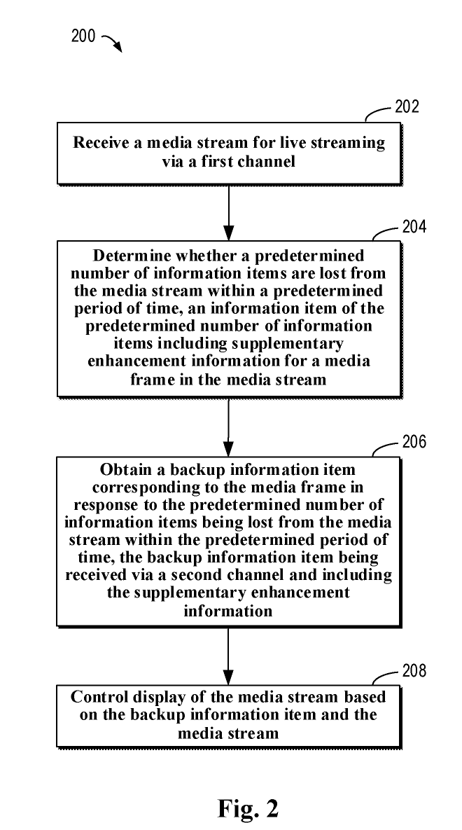

The schematic diagram of the example environment in which the device and/or the method of some embodiments of the present disclosure may be implemented is described above with reference to FIG. 1, and the schematic diagram of an example method 200 for processing a media stream according to some embodiments of the present disclosure is described below with reference to FIG. 2. The example method may be performed by the client 122 in FIG. 1 or any suitable computing device.

As shown in FIG. 2, in the example method 200, at a block 202, the client 122 receives a media stream for live streaming via a first channel 118. For the audience watching live streaming, the audience may use the client to pull the media stream. For example, the first channel 118 may be a media stream transmission channel formed by a content delivery network.

The media stream 104 may include various data streams for live streaming. For example, the media stream 104 may include a video stream for live streaming, and for another example, the media stream 104 may further include an audio stream for live streaming. In addition, before pushing the media stream 104 via the first channel 118, the computing device 102 may further add an information item for the media frame, such as an information item storing supplementary enhancement information, to the media stream.

Next, at a block 204, the client 122 determines whether a predetermined number of information items are lost from the media stream within a predetermined period of time. A target information item of the predetermined number of information items includes supplementary enhancement information for a target media frame in the media stream. For the received media stream, in order to ensure that the media stream can be better presented to the user, it is necessary to further detect whether the information item inserted into the media stream is lost.

In some embodiments, when the client 122 receives the media stream 104 via the first channel 118, the client may also receive a backup information item for the media stream 104 via a second channel 120. When determining whether the predetermined number of information items are lost within the predetermined period of time, a counting operation may be performed, within the predetermined period of time, on the backup information item for the received media stream 104 and the information item detected in the media stream, to determine a first number of backup information items for the media stream 104 received within the predetermined period of time and a second number of information items detected in the media stream 104 within the predetermined period of time. It should be noted that the predetermined period of time is set by the user, and the user may change a duration of the predetermined period of time according to the user's own needs.

Subsequently, the client 122 may determine whether the predetermined number of information items 106 are lost from the media stream 104 within the predetermined period of time based on the first number and the second number obtained from the counting. In an example, when it is determined that the first number is greater than a first threshold number and the second number is equal to a second threshold number, it may be determined that the predetermined number of information items 106 are lost from the media stream 104 within the predetermined period of time. For example, the first threshold number is 3, and the second threshold number is 0. It indicates that three backup information items are received within the predetermined period of time, but no information item is received. At this point, it may be determined that three information items are lost within the predetermined period of time. In another example, when it is determined that the first number is greater than or equal to the first threshold number and the second number is less than the second threshold number, it may be determined that the predetermined number of information items 106 are lost from the media stream 104 within the predetermined period of time. The first number and the second number may be set according to user needs. It should be noted that the rule for determining the loss of the predetermined number of information items 106 may be defined by the user, which is not limited in the present application.

If the predetermined number of information items are not lost from the media stream within the predetermined period of time, the information in the information item obtained from the media stream may be used to the display the media stream to the audience of the client 122.

Then, at a block 206, in response to the predetermined number of information items being lost from the media stream within the predetermined period of time, the client 122 obtains a target backup information item corresponding to the target media frame, the target backup information item being received via the second channel and including the supplementary enhancement information.

In some embodiments, the client 122 may receive the additional message 116 generated by the computing device 102. The additional message 116 may be sent to the client 122 via the second channel 120. The additional message 116 includes a reference timestamp and a backup information item for the media frame in the media stream 104. After receiving the additional message 116, the client 122 stores the paired reference timestamp and backup information item in the mapping for the backup information item and the reference timestamp in the client 122. For example, the obtained reference timestamp and backup information item are stored in a list in the client for storing reference timestamps and backup information items.

After it is determined that the predetermined number of information items 106 are lost from the media stream 104 within the predetermined period of time, the target timestamp 114 corresponding to the target media frame 112 in the media stream 104 at this point needs to be further obtained. In this process, the client 122 may obtain the stored mapping for the backup information item and the reference timestamp. The mapping stores a group of backup information items and a group of reference timestamps, and there is a one-to-one correspondence between the backup information item in the group of backup information items and the timestamp in the group of reference timestamps. Additionally, the group of backup information items and the group of reference timestamps stored in the mapping arrive at the client 122 earlier than the media stream 104.

The client 122 may first determine the media frame in the media stream 104 received within the predetermined period of time, further obtain metadata of the media frame, and then obtain the timestamp for the media frame from the metadata. For example, if the media frame in the media stream 104 received within the predetermined period of time includes the target media frame 112, the target timestamp 114 may be obtained. Subsequently, the determined target timestamp 114 and the mapping are used to determine the target backup information item 106 corresponding to the target timestamp 114 from the group of backup information items.

When obtaining the target backup information item 106, the client 122 needs to search the group of reference timestamps to determine a target reference timestamp corresponding to the target timestamp 114. Subsequently, the client 122 uses the found target reference timestamp to determine the target backup information item 106 corresponding to the target reference timestamp from the mapping between the group of backup information items and the group of reference timestamps.

Due to a certain delay in data transmission, there is also a certain difference between the timestamp corresponding to the media frame in the media stream 104 and the reference timestamp in the group of reference timestamps. Therefore, when it is determined that a difference between the target timestamp 114 and the reference timestamp in the group of reference timestamps is less than a threshold difference, for example, less than 50 ms, the reference timestamp may be determined as the target timestamp 114.

In some embodiments, when initially receiving the media stream 104, the client 122 may determine a reference timestamp corresponding to the media stream 104, such as a timestamp at which the media stream is initially received. Then, the client 122 records a duration elapsed after the media stream is received, and generates an updated timestamp according to a standard timestamp interval. After it is determined that the predetermined number of information items are lost from the media stream within the predetermined period of time, the mapping for the group of backup information items and the group of reference timestamps and the updated timestamp may be further obtained, and the target backup information item 106 corresponding to the updated timestamp may be obtained from the mapping according to the updated timestamp.

In some embodiments, when the corresponding target backup information item is not found in the mapping relationship between the group of backup information items and the group of reference timestamps using the target timestamp, the updated timestamp may be further used to obtain the target backup information item 106 corresponding to the updated timestamp from the mapping. The above examples are only used to describe the present disclosure, rather than to specifically limit the present disclosure.

Finally, at a block 208, the client 122 controls the display of the media stream based on the target backup information item and the media stream.

After the predetermined number of information items 106 within the predetermined period of time are determined to be lost, the client 122 may use the obtained target backup information item 106 and the obtained target timestamp 114 to adjust the media stream 104, so that the media stream 104 may be displayed more stably on the audience side, and the reliability of live streaming is improved.

Through the method, multiple transmission channels may be used to transmit the information items for live streaming, and backup information items may be provided to increase the stability and reliability of live streaming. In the case that the information items are lost due to poor network conditions, the transmitted backup information items may also be used to implement live streaming, thereby improving the stability of live streaming, and greatly improving the live streaming experience and audience experience.

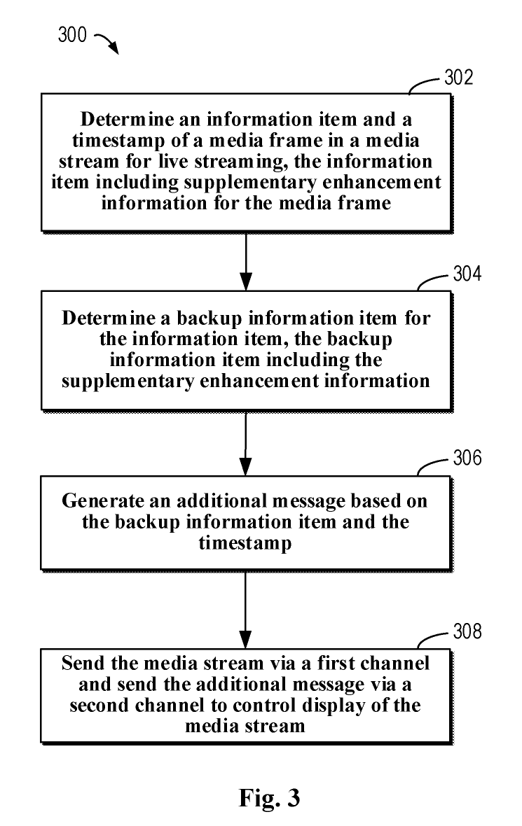

The schematic diagram of the example method 200 for processing a media stream according to some embodiments of the present disclosure is described above with reference to FIG. 2, and the schematic diagram of an example method 300 for processing a media stream according to some embodiments of the present disclosure is described below with reference to FIG. 3. The example method 300 may be performed by the computing device 102 in FIG. 1.

As shown in FIG. 3, in the example method 300, at a block 302, the computing device 102 determines a target information item and a target timestamp of a target media frame in a media stream for live streaming, the target information item including supplementary enhancement information for the target media frame. Additionally, the target media frame may be any frame in a video stream.

In some embodiments, when the computing device 102 is used for live streaming, for a media frame in a media stream to be generated, the computing device may generate a corresponding information item. The information item includes supplementary enhancement information for the media frame. Then, the computing device 102 may add the supplementary enhancement information to the video stream to push the information to the audience side.

The media stream 104 is determined based on an original media stream. In an example, the original media stream includes a video stream for live streaming. In another example, the original media stream includes an audio stream for live streaming. Additionally, operations such as acquisition and merging may be performed on the original media stream from a streamer and/or the original media streams from other users (such as guests participating in live streaming) to generate the media stream 104.

Next, at a block 304, the computing device 102 determines a target backup information item for the target information item, the target backup information item including the supplementary enhancement information. Since the media stream 104 may cause the loss of information item during the transmission process via the first channel 118, the computing device 102 also determines the target backup information item 106 for the target information item 108, and the target backup information item 106 also includes the supplementary enhancement information in the target information item 108.

Then, at a block 306, the computing device 102 generates an additional message based on the target backup information item and the target timestamp. In order to send the target backup information item and the target timestamp to the client 122, the computing device 102 places the target backup information item and the target timestamp in the additional message that may be transmitted to the client 122 via a service server.

Additionally, in order to reduce the number of transmitted additional messages, the computing device 102 may place the backup information item and the target timestamp within a period of time in the additional message 116.

Finally, at a block 308, the computing device 102 sends the media stream via the first channel and sends the additional message via the second channel to control the display of the media stream. After generating the media stream and the additional message, the computing device 102 will send them to the client through different channels.

For example, the computing device 102 uses the first channel composed of the content delivery network to send the media stream to the client 122. The computing device 102 may further send the generated additional message 116 to the client 122 via the second channel 120, which is implemented through the server of the live streaming application. The client 122 may determine the timestamp and the corresponding backup information item from the additional message according to a preset rule. Then, the client 122 may use the method described above with reference to FIG. 2 to control the display of the media stream 104 on the client 122.

Through the method, multiple transmission channels may be used to transmit the information items for live streaming, and backup information items may be provided to increase the stability and reliability of live streaming. Therefore, in the case that the information items are lost due to poor network conditions, the transmitted backup information items may be used to improve the stability of live streaming, greatly improving the live streaming experience and audience experience.

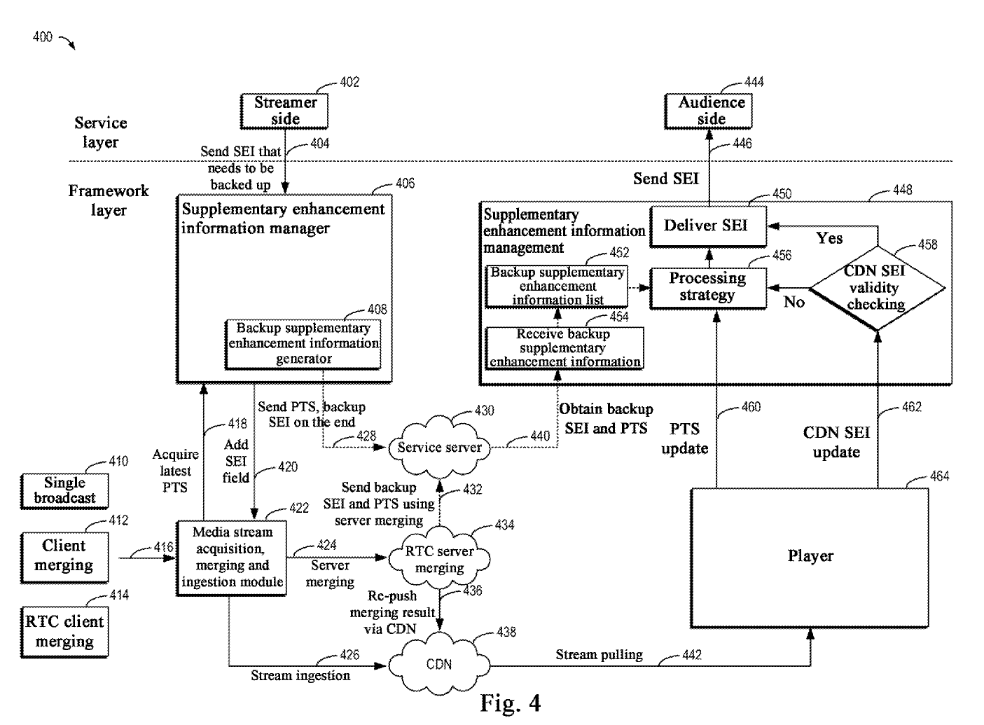

The schematic diagram of the example method 300 for processing a media stream according to some embodiments of the present disclosure is described above with reference to FIG. 3, and the schematic diagram of an example of a flowchart for processing a media stream according to some embodiments of the present disclosure is described below with reference to FIG. 4.

As shown in FIG. 4, in an example 400, taking a live streaming scenario as an example, a service layer includes a streamer side 402 and an audience side 444, and a framework layer includes supplementary enhancement information management 406 for the streamer side 402 and supplementary enhancement information 448 for the audience side 444. It should be noted that the information item may only include supplementary enhancement information, and the following example illustrates the related information by taking the information item as supplementary enhancement information SEI, the first channel as a content delivery network (CDN), and the second channel as a service server.

First, at 404, the streamer side 402 sends SEI that needs to be backed up to a supplementary enhancement information manager 406, and a backup supplementary enhancement information generator 408 generates backed up SEI. Subsequently, an SEI field is added to a media stream acquisition, merging and ingestion module 422 at 420, and at 418, the media stream acquisition, merging and ingestion module 422 further provides the latest presentation timestamp PTS obtained to the supplementary enhancement information manager 406 after generating the merged media stream, for the backup supplementary enhancement information generator 408 to generate a PTS and backup SEI pair.

The media stream acquisition, merging and ingestion module 422 may acquire original media streams from single broadcast 410, client merging 412 and RTC client merging 414, and then perform acquisition and merging operations on the acquired original media streams at the media stream acquisition, merging and ingestion module 422 to generate a processed media stream. After the original media stream is acquired, it needs to be sent to the media stream acquisition, merging and ingestion module 422 at 416.

The media stream acquisition, merging and ingestion module 422 may further perform stream ingestion 426 on the processed media stream, and transmit the media stream to a player 464 on the audience side via a CDN 438.

In some embodiments, in addition to merging streams on the streamer side to transmit the media stream, the merging operation may not be performed on the streamer side. In this case, the media stream may be merged on the server side at 424, and the media stream and the corresponding PTS and backup SEI pair may be generated through RTC server merging 434. Subsequently, the CDN of the merging result is re-pushed to the CDN 438 at 436, to transmit the media stream to the audience side via the CDN 428. The media stream includes SEI and PTS for a video frame.

After receiving the media stream, the audience side updates the PTS at 460, and the frequency of updating the PTS is set by the user. The audience side also updates the CDN SEI at 462, that is, updates the SEI obtained in the media stream.

Subsequently, CDN SEI validity checking is performed at 458, which is used to determine whether a predetermined number of information items are lost within a predetermined period of time, that is, whether a predetermined number of CDN SEIs are lost within the predetermined period of time.

If it is determined that the predetermined number of CDN SEIs are not lost within the predetermined period of time, the SEI is directly delivered at 450, and the SEI is sent at 446 and transmitted to the audience side 444 of the service layer together.

In addition, the client further obtains the backup SEI and the PTS at 440, and then receives backup supplementary enhancement information at 454 to form a backup supplementary enhancement information list 452, in which a mapping between backup supplementary enhancement information and PTSs is stored. If it is determined that the predetermined number of CDN SEIs are lost within the predetermined period of time, a target backup SEI corresponding to a target timestamp is determined using the backup supplementary enhancement information list 452 at a processing policy 456, and the target backup SEI is sent at 446 for use at the audience side 444 of the service layer.

The backup SEI is generated on the streamer side. After the backup SEI and the corresponding PTS are generated, the PTS and the backup SEI may be sent on the end at 428, and the backup SEI and the PTS are sent to the audience side via a service server 430.

In some embodiments, the backup SEI and the PTS may also be sent using server merging from the result of RTC server merging at 432.

Through the method, multiple transmission channels may be used to transmit the information items for live streaming, and backup information items may be provided, which increases the stability and reliability of live streaming, and greatly improves the audience experience.

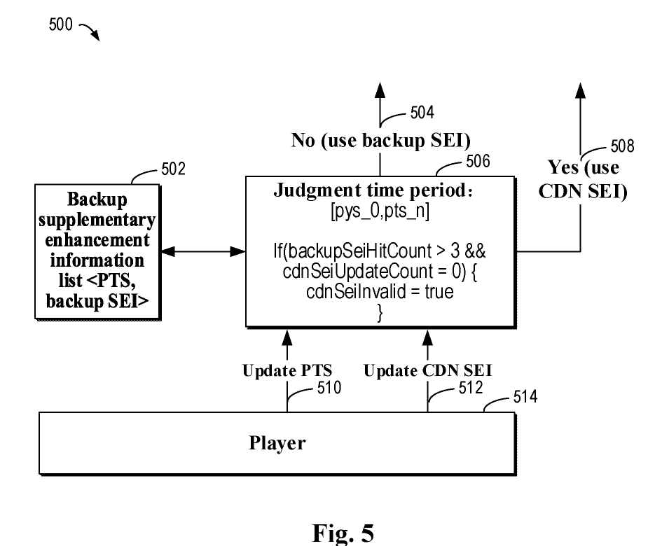

The schematic diagram of the example of the flowchart for processing a media stream according to some embodiments of the present disclosure is described above with reference to FIG. 4, and the schematic diagram of an example of detecting an information item according to some embodiments of the present disclosure is described below with reference to FIG. 5.

As shown in FIG. 5, in an example 500, in combination with the previous example 400, when determining whether a predetermined number of information items are lost within a predetermined period of time, an alternative supplementary enhancement information list <PTS, backup SEI> 502 and a player 514 may be used.

Within the predetermined period of time, the player 514 is used to update the PTS at 510 and update the CDN SEI at 512, to update the timestamp and the supplementary enhancement information in the media stream, and the backup SEI and the PTS in the backup supplementary enhancement information list may also be obtained.

Subsequently, it is determined whether a predetermined number of supplementary enhancement information are lost within the predetermined period of time using a preset rule in example code 506. For example, when it is determined according to the example code that the number of supplementary enhancement information in the media stream within a predetermined period of time pts_0 to pts_n is 0 and the number of alternative supplementary enhancement information is greater than 3, it may be determined that the predetermined number of supplementary enhancement information are lost within the predetermined period of time. In this case, the alternative SEI is used at 504.

If the preset rule in the example code is not satisfied, it may be determined that the predetermined number of supplementary enhancement information are not lost within the predetermined period of time. In this case, the CND SEI is used at 508.

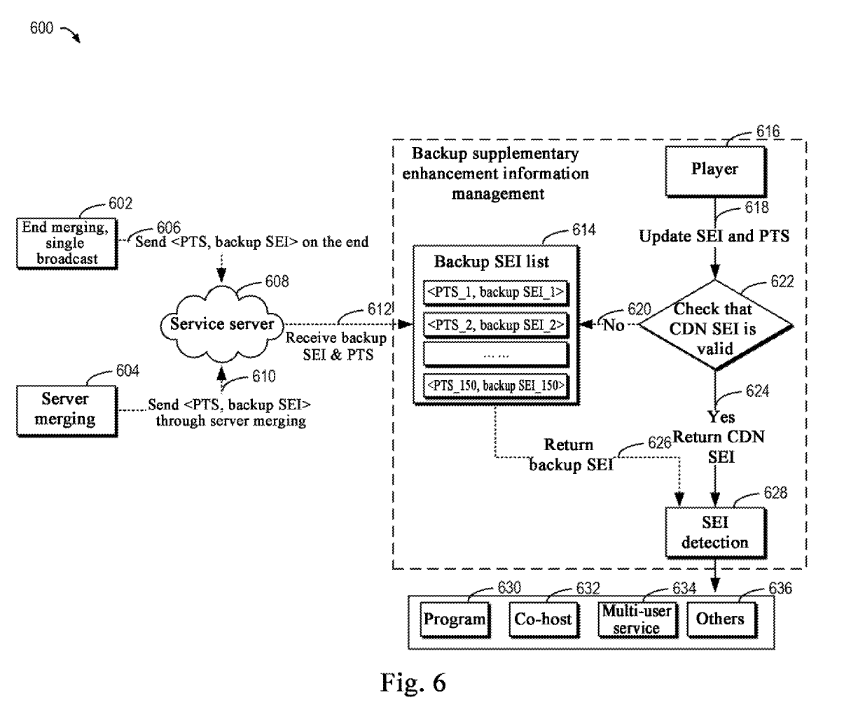

The schematic diagram of the example of detecting an information item according to some embodiments of the present disclosure is described above with reference to FIG. 5, and the schematic diagram of an example of determining a target backup information item according to some embodiments of the present disclosure is described below with reference to FIG. 6.

As shown in FIG. 6, in an example 600, in combination with the previous example 400 and example 500, a method for determining target backup supplementary enhancement information is to send the PTS and the backup SEI on the end at 606 after end merging, single broadcast 602 and server merging 604, and perform server merging to send the PTS and the backup SEI to a service server 608 at 610. Subsequently, at 612, the audience side receives the backup SEI and the PTS. The backup SEI and the PTS may be received through an open source data transmission platform or instant messaging (IM).

Subsequently, the SEI and the PTS are updated at 618 by a player 616, and a determination operation is performed at 622 to detect whether the CDN SEI is valid, that is, whether a predetermined number of supplementary enhancement information are lost within a predetermined period of time. When it is determined that the predetermined number of supplementary enhancement information are lost within the predetermined period of time, at 620, the target timestamp in the media stream is used to perform matching in a group of reference timestamps in a backup SEI list 614. After the matching is successful, the backup SEI is returned at 626, and the backup SEI is sent to multiple services, such as a program 630, a co-hosting 632, a multi-user service 634, and/or others 636, using SEI detection 628.

When it is determined that the predetermined number of supplementary enhancement information are not lost within the predetermined period of time, the CDN SEI is returned at 624, and then the SEI is sent to multiple services, such as the program 630, the co-hosting 632, the multi-user service 634, and/or others 636, using the SEI detection 628.

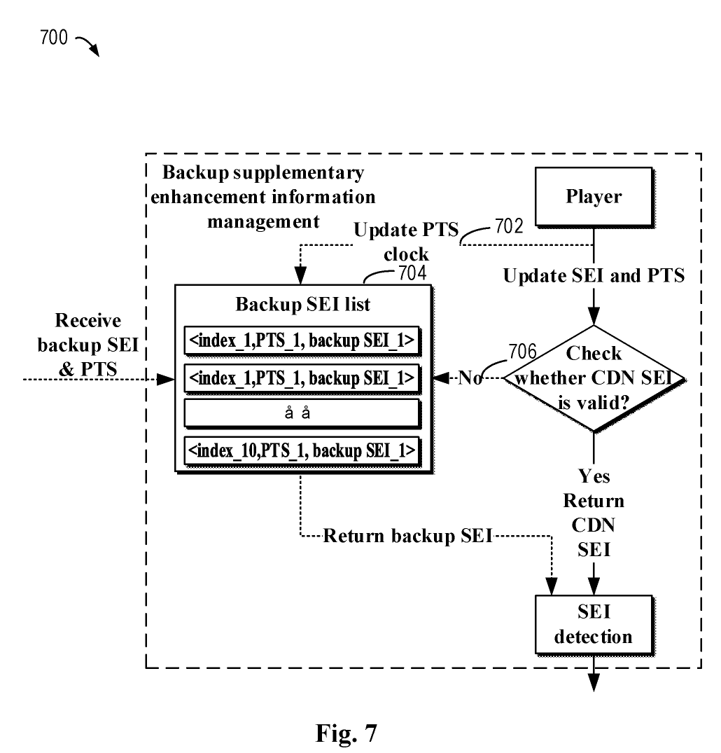

The schematic diagram of the example of determining the target backup information item for processing the media stream according to some embodiments of the present disclosure is described above with reference to FIG. 6, and the schematic diagram of another example of determining the target backup information item according to some embodiments of the present disclosure is described below with reference to FIG. 7.

As shown in FIG. 7, in an example 700, in combination with the previous example 600, it may be detected whether the CDN SEI is valid, that is, whether a predetermined number of supplementary enhancement information are lost within a predetermined period of time is determined. When it is detected that the CDN SEI is invalid, a backup SEI allocation operation is started at 706. At this time, the PTS clock is updated at 702 to determine the backup SEI corresponding to the updated timestamp from a backup SEI list 704, and the backup SEI is returned. The updated PTS clock is determined using a reference timestamp, a duration from a current moment to the reference timestamp, and a standard time interval between timestamps. For example, how many standard time intervals have elapsed within the duration is used, and then the number of standard intervals may be used as an index, or the duration corresponding to a plurality of standard time intervals may be added to the reference timestamp to obtain the current updated timestamp. When it is determined that the predetermined number of supplementary enhancement information are not lost within the predetermined period of time, the CDN SEI is directly returned.

It should be particularly noted that the two methods for determining the target backup supplementary enhancement information in the example 600 and the example 700 are different, and the user may select any one of the methods to determine the target backup supplementary enhancement information.

Additionally, the method in the example 600 may be first selected to determine the target backup supplementary enhancement information, and when the method in the example 600 cannot determine the target backup supplementary enhancement information, the method in the example 700 may be selected to determine the target backup supplementary enhancement information.

The schematic diagram of another example of determining the target backup information item according to some embodiments of the present disclosure is described above with reference to FIG. 7.

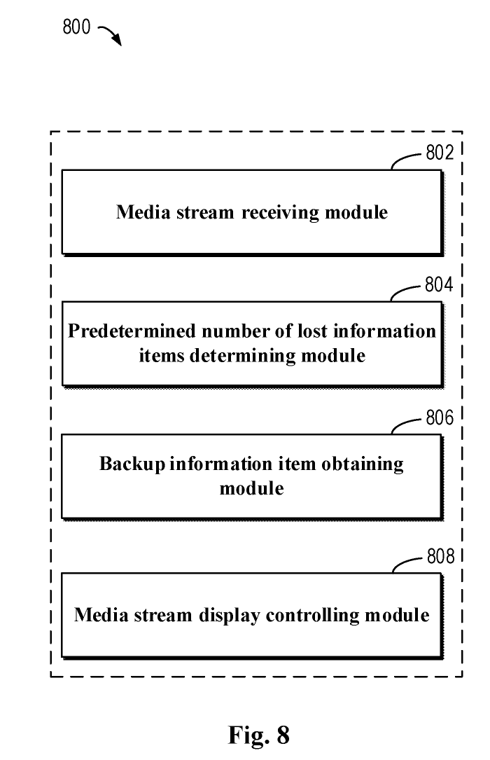

As shown in FIG. 8, the apparatus 800 includes a media stream receiving module 802 configured to receive, via a first channel, a media stream for live streaming; a predetermined number of lost information items determining module 804 configured to determine whether a predetermined number of information items are lost from the media stream within a predetermined period of time, a target information item of the predetermined number of information items including supplementary enhancement information for a target media frame in the media stream; a target backup information item obtaining module 806 configured to, in response to the predetermined number of information items being lost from the media stream within the predetermined period of time, obtain a target backup information item corresponding to the target media frame, the target backup information item being received via a second channel and including the supplementary enhancement information; and a media stream display controlling module 808 configured to control the display of the media stream based on the target backup information item and the media stream.

In some embodiments, the predetermined number of lost information items determining module 804 includes: a first number and second number counting module configured to count a first number of backup information items for the media stream received via the second channel within the predetermined period of time and a second number of information items detected in the media stream within the predetermined period of time; and a predetermined number of lost information items determining module configured to determine whether the predetermined number of information items are lost from the media stream within the predetermined period of time based on the first number and the second number.

In some embodiments, the predetermined number of lost information items determining module includes: a first number and second number determining module configured to determine whether the first number is greater than a first threshold number and whether the second number is equal to a second threshold number; and a predetermined number of lost information items determining module configured to, in response to the first number being greater than the first threshold number and the second number being equal to the second threshold number, determine that the predetermined number of information items are lost from the media stream within the predetermined period of time.

In some embodiments, the target backup information item obtaining module 806 includes: a target timestamp obtaining module configured to, in response to the predetermined number of information items being lost from the media stream within the predetermined period of time, obtain a target timestamp corresponding to the target media frame; a mapping determining module configured to determine a mapping for a group of backup information items and a group of reference timestamps; and a target backup information item determining module configured to determine the target backup information item corresponding to the target timestamp from the group of backup information items based on the target timestamp and the mapping.

In some embodiments, the target timestamp obtaining module includes: a target media frame determining module configured to determine the target media frame in the media stream received within the predetermined period of time; and a target timestamp obtaining module configured to obtain the target timestamp of the target media frame from metadata of the target media frame.

In some embodiments, the target backup information item determining module includes: a target reference timestamp searching module configured to search for a target reference timestamp corresponding to the target timestamp in the group of reference timestamps; and a target information item determining module configured to determine a backup information item corresponding to the target reference timestamp in the mapping as the target information item.

In some embodiments, the target reference timestamp searching module includes: a difference between the target timestamp and the reference timestamp determining module configured to determine a difference between the target timestamp and a reference timestamp in the group of reference timestamps; and a target reference timestamp determining module configured to, in response to the difference being less than a threshold difference, determine the reference timestamp as the target reference timestamp.

In some embodiments, the apparatus 800 further includes: an additional message receiving module configured to receive an additional message for the media stream via the second channel, the additional message including a reference timestamp and a backup information item for a media frame in the media stream; and a mapping generating module configured to generate the mapping based on the reference timestamp and the backup information item.

In some embodiments, the target backup information item obtaining module 806 includes: a reference timestamp determining module configured to determine a reference timestamp corresponding to the media stream; an updated timestamp generating module configured to generate an updated timestamp based on the reference timestamp and an elapsed duration; a mapping determining module configured to determine a mapping for a group of backup information items and a group of reference timestamps; and a target backup information item obtaining module configured to obtain the target backup information item corresponding to the updated timestamp from the mapping based on the updated timestamp.

In some embodiments, the first channel includes a content delivery network and the second channel includes a service server for live streaming.

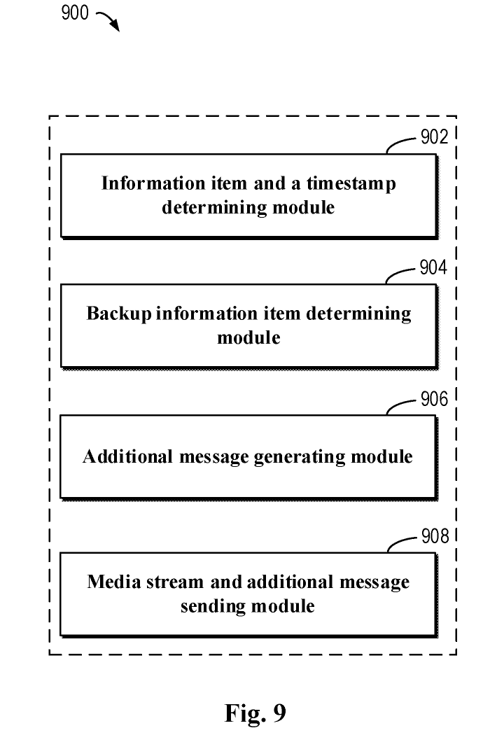

As shown in FIG. 9, the apparatus 900 includes a target information item and a target timestamp determining module 902 configured to determine a target information item and a target timestamp of a target media frame in a media stream for live streaming, the target information item including supplementary enhancement information for the target media frame; a target backup information item determining module 904 configured to determine a target backup information item for the target information item, the target backup information item including the supplementary enhancement information; an additional message generating module 906 configured to generate an additional message based on the target backup information item and the target timestamp; and a media stream and additional message sending module 908 configured to send the media stream via a first channel and send the additional message via a second channel to control the display of the media stream.

In some embodiments, the apparatus 900 further includes: an original media stream obtaining module configured to obtain a group of original media streams; and a media stream generating module configured to generate the media stream based on the group of original media streams.

In some embodiments, the first channel includes a content delivery network and the second channel includes a service server for live streaming.

In some embodiments, the method is performed at a client or a real-time communication server.

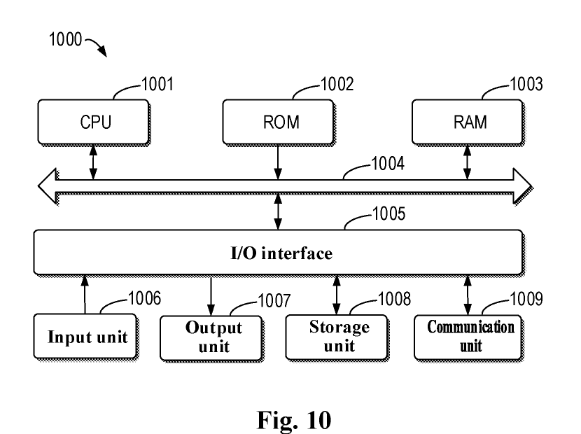

FIG. 10 shows a schematic block diagram of an example device 1000 that may be used to implement the embodiments of the present disclosure. The computing device 102 and the client 122 in FIG. 1 may be implemented using the device 1000. As shown in the figure, the device 1000 includes a central processing unit (CPU) 1001 that may perform various appropriate actions and processing according to computer program instructions stored in a read-only memory (ROM) 1002 or computer program instructions loaded from a storage unit 1008 into a random access memory (RAM) 1003. In the RAM 1003, various programs and data required for operations of the device 1000 may also be stored. The CPU 1001, the ROM 1002, and the RAM 1003 are connected to each other through a bus 1004. An input/output (I/O) interface 1005 is also connected to the bus 1004.

Multiple components in the device 1000 are connected to the I/O interface 1005, and the components include: an input unit 1006, such as a keyboard, a mouse, etc.; an output unit 1007, such as various types of displays, speakers, etc.; the storage unit 1008, such as a magnetic disk, an optical disc, etc.; and a communication unit 1009, such as a network card, a modem, a wireless communication transceiver, etc. The communication unit 1009 allows the device 1000 to exchange information/data with other devices through a computer network such as Internet and/or various telecommunication networks.

The various processes and processing described above, such as the method 200, the method 300, and examples 400 to 700, may be executed by the processing unit 1001. For example, in some embodiments, the method 200, the method 300, and examples 400 to 700 may be implemented as a computer software program, which is tangibly contained in a machine-readable medium, such as the storage unit 1008. In some embodiments, part or entirety of the computer program may be loaded and/or installed into the device 1000 via the ROM 1002 and/or the communication unit 1009. When the computer program is loaded into the RAM 1003 and executed by the CPU 1001, one or more actions of the example method 200, the example method 300, and examples 400 to 700 described above may be executed.

The present disclosure may be a method, an apparatus, a system, and/or a computer program product. The computer program product may include a computer-readable storage medium having computer-readable program instructions for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device, such as a punched card or a raised structure in a groove with instructions stored thereon, and any suitable combination of the above. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from a computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages such as Smalltalk, C++, and conventional procedural programming languages such as "C" language or similar programming languages. The computer-readable program instructions may be executed entirely on a user's computer, partly executed on a user's computer, executed as an independent software package, partly executed on a user's computer and partly executed on a remote computer, or entirely executed on a remote computer or a server. In the case involving a remote computer, the remote computer may be connected to a user's computer through any kind of network, including a local area network (LAN) or a wide area network (WAN), or it may be connected to an external computer (for example, connected by using Internet provided by an Internet service provider). In some embodiments, by personalizing an electronic circuit, such as a programmable logic circuit, a field programmable gate array (FPGA) or a programmable logic array (PLA), using state information of the computer-readable program instructions, the electronic circuit may execute the computer-readable program instructions, thereby implementing various aspects of the present disclosure.

Various aspects of the present disclosure are described herein with reference to flowcharts and/or block diagrams of a method, an apparatus (system), and a computer program product according to embodiments of the present disclosure. It should be appreciated that each block of the flowchart and/or block diagram, and a combination of blocks in the flowchart and/or block diagram may be implemented by the computer-readable program instructions.

These computer-readable program instructions may be provided to a processing unit of a general-purpose computer, a dedicated computer, or another programmable data processing apparatus to produce a machine, such that these instructions, when executed by the processing unit of the computer or another programmable data processing apparatus, produce an apparatus for implementing a function/action specified in one or more blocks of the flowchart and/or the block diagram. These computer-readable program instructions may also be stored in a computer-readable storage medium, and these instructions cause a computer, a programmable data processing apparatus, and/or other devices to work in a specific manner, such that the computer-readable medium having the instructions stored therein includes an article of manufacture, which includes instructions for implementing various aspects of the function/action specified in one or more blocks of the flowchart and/or the block diagram.

The computer-readable program instructions may also be loaded onto a computer, another programmable data processing apparatus, or other devices, such that a series of operations and steps are performed on the computer, the another programmable data processing apparatus, or the other devices to produce a computer-implemented process, so that the instructions executed on the computer, the another programmable data processing apparatus, or the other devices implement the function/action specified in one or more blocks of the flowchart and/or the block diagram.

The flowchart and block diagram in the drawings show the possibly implemented architectures, functions, and operations of the system, the method, and the computer program product according to multiple embodiments of the present disclosure. In this regard, each block in the flowchart or block diagram may represent a module, program segment, or part of an instruction, and the module, program segment, or part of an instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of blocks in the block diagram and/or the flowchart may be implemented by a dedicated hardware-based system that performs a specified function or action, or may be implemented by a combination of dedicated hardware and computer instructions.

The embodiments of the present disclosure have been described above, and the above description is exemplary, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the actual application or technical improvement to the technology in the market, or to enable other persons of ordinary skill in the art to understand the embodiments disclosed herein.

We claim:

1. A method for processing a media stream, comprising:
receiving, via a first channel, a media stream for live streaming;
determining whether a predetermined number of information items are lost from the media stream within a predetermined period of time, an information item of the predetermined number of information items comprising supplementary enhancement information for a media frame in the media stream;
obtaining, in response to the predetermined number of information items being lost from the media stream within the predetermined period of time, a backup information item corresponding to the media frame, the backup information item being received via a second channel and comprising the supplementary enhancement information; and
controlling a display of the media stream based on the backup information item and the media stream.

2. The method of claim 1, wherein determining whether the predetermined number of information items are lost from the media stream within the predetermined period of time comprises:
counting a first number of backup information items for the media stream received via the second channel within the predetermined period of time and a second number of information items detected in the media stream within the predetermined period of time; and
determining whether the predetermined number of information items are lost from the media stream within the predetermined period of time based on the first number and the second number.

3. The method of claim 2, wherein determining whether the predetermined number of information items are lost from the media stream within the predetermined period of time based on the first number and the second number comprises:
determining whether the first number is greater than a first threshold number and whether the second number is equal to a second threshold number; and
determining, in response to the first number being greater than the first threshold number and the second number being equal to the second threshold number, that the predetermined number of information items are lost from the media stream within the predetermined period of time.

4. The method of claim 1, wherein obtaining the backup information item corresponding to the media frame comprises:
obtaining, in response to the predetermined number of information items being lost from the media stream within the predetermined period of time, a timestamp corresponding to the media frame;
determining a mapping for a group of backup information items and a group of reference timestamps; and
determining a backup information item corresponding to the timestamp from the group of backup information items based on the timestamp and the mapping.

5. The method of claim 4, wherein obtaining the timestamp corresponding to the media frame comprises:
determining the media frame in the media stream received within the predetermined period of time; and
obtaining the timestamp of the media frame from metadata of the media frame.

6. The method of claim 4, wherein determining the backup information item corresponding to the timestamp from the group of backup information items comprises:
searching for a reference timestamp corresponding to the timestamp in the group of reference timestamps; and
determining a backup information item corresponding to the reference timestamp in the mapping as the backup information item.

7. The method of claim 6, wherein searching for the reference timestamp corresponding to the timestamp in the group of reference timestamps comprises:
determining a difference between the timestamp and a reference timestamp in the group of reference timestamps; and
determining, in response to the difference being less than a threshold difference, the reference timestamp as the reference timestamp.

8. The method of claim 4, further comprising:
receiving an additional message for the media stream via the second channel, the additional message comprising a reference timestamp and a backup information item for a media frame in the media stream; and
generating the mapping based on the reference timestamp and the backup information item.

9. The method of claim 1, wherein obtaining the backup information item corresponding to the media frame comprises:
determining a reference timestamp corresponding to the media stream;
generating an updated timestamp based on the reference timestamp and an elapsed duration;
determining a mapping for a group of backup information items and a group of reference timestamps; and
obtaining a backup information item corresponding to the updated timestamp from the mapping based on the updated timestamp.

10. The method of claim 1, wherein the first channel comprises a content delivery network and the second channel comprises a service server for the live streaming.

11. A method for processing a media stream, comprising:
determining an information item and a timestamp of a media frame in a media stream for live streaming, the information item comprising supplementary enhancement information for the media frame;
determining a backup information item for the information item, the backup information item comprising the supplementary enhancement information;
generating an additional message based on the backup information item and the timestamp; and
sending the media stream via a first channel and sending the additional message via a second channel to control a display of the media stream.

12. The method of claim 11, further comprising:
obtaining a group of original media streams; and
generating the media stream based on the group of original media streams.

13. The method of claim 11, wherein the first channel comprises a content delivery network and the second channel comprises a service server for the live streaming.

14. The method of claim 11, wherein the method is performed at a client or a real-time communication server.

15. An electronic device, comprising:
at least one processor; and
a memory for storing at least one program, wherein the at least one program, when executed by the at least one processor, causes the at least one processor to:
receive, via a first channel, a media stream for live streaming;
determine whether a predetermined number of information items are lost from the media stream within a predetermined period of time, an information item of the predetermined number of information items comprising supplementary enhancement information for a media frame in the media stream;
obtain, in response to the predetermined number of information items being lost from the media stream within the predetermined period of time, a backup information item corresponding to the media frame, the backup information item being received via a second channel and comprising the supplementary enhancement information; and
control a display of the media stream based on the backup information item and the media stream.

16. The electronic device according to claim 15, wherein the at least one program causing the at least one processor to determine whether the predetermined number of information items are lost from the media stream within the predetermined period of time further causes the at least one processor to:
count a first number of backup information items for the media stream received via the second channel within the predetermined period of time and a second number of information items detected in the media stream within the predetermined period of time; and
determine whether the predetermined number of information items are lost from the media stream within the predetermined period of time based on the first number and the second number.

17. The electronic device according to claim 16, wherein the at least one program causing the at least one processor to determine whether the predetermined number of information items are lost from the media stream within the predetermined period of time based on the first number and the second number further causes the at least one processor to:
determine whether the first number is greater than a first threshold number and whether the second number is equal to a second threshold number; and
determine, in response to the first number being greater than the first threshold number and the second number being equal to the second threshold number, that the predetermined number of information items are lost from the media stream within the predetermined period of time.

18. The electronic device according to claim 15, wherein the at least one program causing the at least one processor to obtain the backup information item corresponding to the media frame further causes the at least one processor to:
obtain, in response to the predetermined number of information items being lost from the media stream within the predetermined period of time, a timestamp corresponding to the media frame;
determine a mapping for a group of backup information items and a group of reference timestamps; and
determine a backup information item corresponding to the timestamp from the group of backup information items based on the timestamp and the mapping.

19. The electronic device according to claim 18, wherein the at least one program causing the at least one processor to obtain the timestamp corresponding to the media frame further causes the at least one processor to:
determine the media frame in the media stream received within the predetermined period of time; and
obtain the timestamp of the media frame from metadata of the media frame.

20. The electronic device according to claim 18, wherein the at least one program causing the at least one processor to determining the backup information item corresponding to the timestamp from the group of backup information items further causes the at least one processor to:
search for a reference timestamp corresponding to the timestamp in the group of reference timestamps; and
determine a backup information item corresponding to the reference timestamp in the mapping as the backup information item.
